(19) United States
(12) Patent Application Publication
(10) Pub. No.: US 2016/0186791 A1
(43) Pub. Date: Jun. 30, 2016

(54) Leg Locking Device For A Tripod

(71) Applicant: Foshan Nanhai Chevan Optical Electronics Co., Ltd., Foshan (CN)

(72) Inventor: Li-Wha Lee, Foshan (CN)

(21) Appl. No.: 14/790,327

(22) Filed: Jul. 2, 2015

(30) Foreign Application Priority Data
Dec. 25, 2014 (CN) 201420843756.8

(51) Int. Cl. F16B 7/14; F16M 11/32

(52) U.S. Cl. CPC F16B 7/1454; F16M 11/32; F16B 7/1472

(57) ABSTRACT

A leg locking device for a tripod including a buckle base that telescopes a leg, a buckle, and a steel belt, the buckle including a cam and a pinch plate, the cam is, through a shaft, connected to one end of the buckle base, one end of the pinch plate is fixed on the cam, and the other end of the pinch plate bends into an arc inward along the buckle base, and the steel belt rounds the cam and is fixed at the other end of the buckle base reversely with the pinch plate. By cam rotation, the cam gradually increases the pulling force on the steel belt during rotation, so that the buckle base is deformed and compressed on the leg. The pinch plate can be pressed onto the buckle base under the reaction force of the steel belt, so that the leg is rapidly locked.

### CROSS-REFERENCE TO RELATED APPLICATIONS

This application claims the benefit of CN Utility Model Application No. 201420843756.8, filed 25 Dec. 2014, the entire contents and substance of which are hereby incorporated by reference.

### BACKGROUND OF THE INVENTION

1. Field of the Invention

The invention relates generally to accessories for photographic equipments, and namely to a leg locking device for a tripod.

2. Description of Related Art

The leg buckle assembly of the existing photographic tripod is mostly locked by assembling with a buckle through screw arbor and screw thread. Although this locking structure can achieve the locking function, it has disadvantages: the locking structure is so bulky and heavy that it makes the overall size and weight of the tripod not convenient to carry; in addition, the locking process is neither convenient nor easy to operate.

### BRIEF SUMMARY OF THE INVENTION

The present invention, in order to conquer the shortcomings in the prior art, provides a leg locking device for a tripod.

The present invention is realized by adopting the following technical solution:

A leg locking device for a tripod comprises a buckle base that telescopes a leg, a buckle and a steel belt; the buckle base is in a form of a circular ring and is arranged with an opening; the buckle comprises a cam and a pinch plate; the cam is, through a shaft, connected to one end of the buckle base; one end of the pinch plate is fixed on the cam, and the other end of the pinch plate bends into an arc inward along the buckle base; the steel belt rounds the cam and is fixed at the other end of the buckle base reversely with the pinch plate.

Preferably, the leg locking device for a tripod further comprises an adjustment structure that is fixed on the buckle base, with one end of the adjustment structure pressed on the leg, to adjust the locking extent; the specific structure of the adjustment structure is as following: the adjustment structure comprises a compact and an adjustment screw; the compact is placed between the buckle base and the leg; the adjustment screw is turned to penetrate the buckle base and is pressed onto the compact; through turning the adjustment screw to adjust the force of the compact on the leg, the degree of tightness of the whole locking device is adjusted.

Preferably, the cam is connected to the buckle base through an inserting shaft.

Compared with the prior art, the advantageous effects of the present invention is, among other things: in the present invention, a buckle shaft is connected to one end of the buckle through shaft, and the steel belt is fixed at the other end reversely after rounding the cam of the buckle; by using of the principle of cam rotation, the cam gradually increases the pulling force on the steel belt during rotation, so that the buckle base is deformed and compressed on the leg; when the cam is rotated to the maximum distance, the cam is still continuously rotated to make the pinch plate pressed onto the buckle base under the reaction force of the steel belt, so that the leg is rapidly locked. The present invention is of simple structure, small size, light weight, easy carrying, easy operation, and wide applicability.

These and other objects, features and advantages of the present invention will become more apparent upon reading the following specification in conjunction with the accompanying drawing figures.

### BRIEF DESCRIPTION OF THE DRAWINGS

Various features and advantages of the present invention may be more readily understood with reference to the following detailed description taken in conjunction with the accompanying drawings, wherein like reference numerals designate like structural elements, and in which:

FIG. 1 is a view of the structure of a leg locking device for a tripod in the present invention;

FIG. 2 is an exploded view of the structure of a leg locking device for a tripod in the present invention;

FIG. 3 is a view of use status of a leg locking device for a tripod in the present invention;

FIG. 4 is another view of the structure of a leg locking device for a tripod in the present invention.

### DETAILED DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The following is a further description of the preferable embodiments of the present invention in combination with the figures.

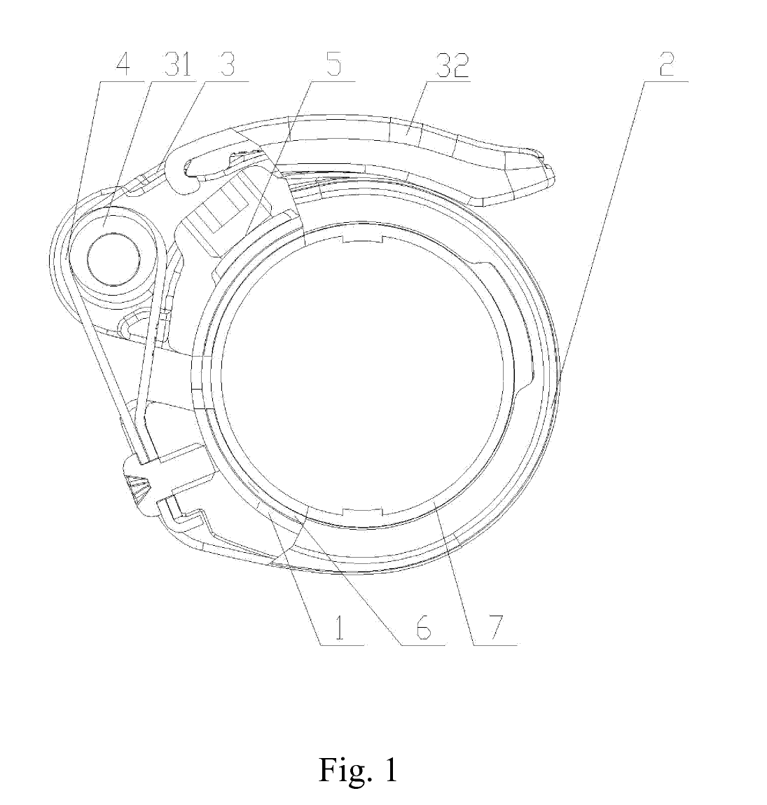

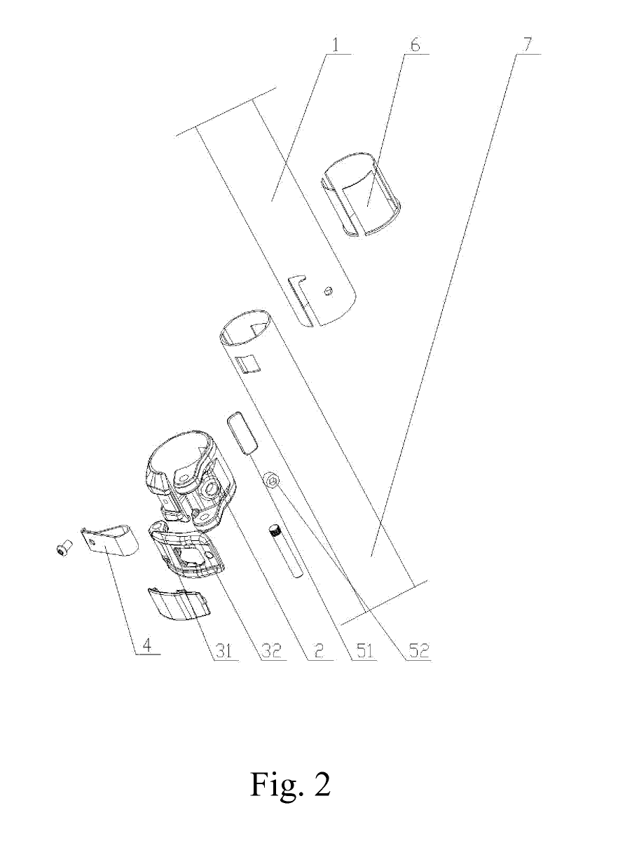

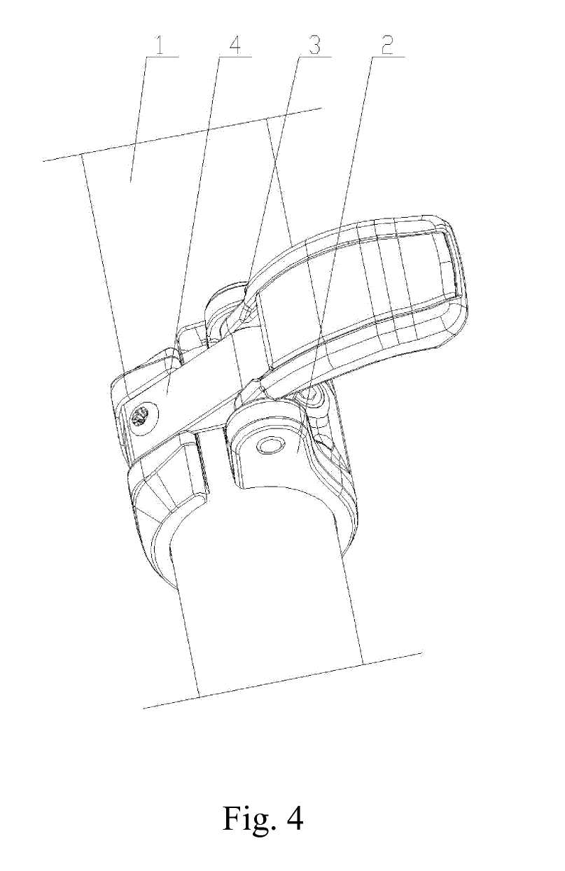

As shown in FIGS. 1 to 4, a leg locking device for a tripod in this embodiment comprises a buckle base 2 that telescopes a leg 1, a buckle 3, a steel belt 4 and an adjustment structure 5; the leg 1 is telescoped with an opening finger 6 inside; a leg connecting tube 7 is telescoped in the opening finger 6 and can be pulled freely inside the opening finger 6; the buckle base 2 is in a form of a circular ring and is arranged with an opening; the buckle 3 comprises a cam 31 and a pinch plate 32; the cam 31 is, through an inserting shaft, connected to one end of the buckle base 2; one end of the pinch plate 32 is fixed on the cam 31, and the other end of the pinch plate 32 bends into an arc inward along the buckle base 2; the steel belt 4 rounds the cam 31 and is fixed at the other end of the buckle base 2 reversely with the pinch plate 32; the adjustment structure 5 is fixed on the buckle base 2, with one end of the adjustment structure 5 pressed on the leg 1.

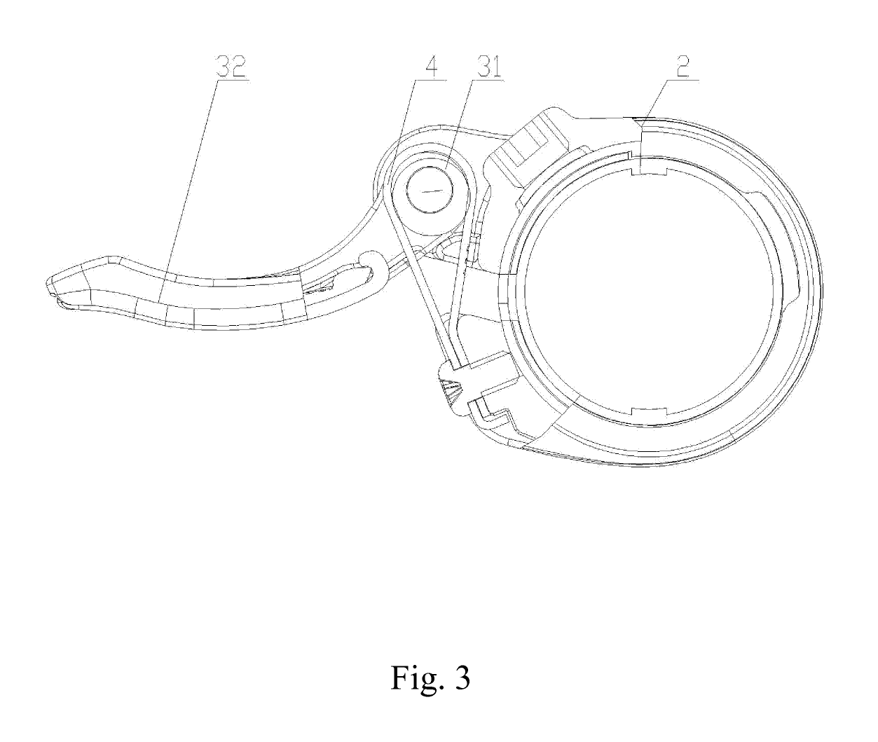

In the leg locking device for a tripod, the leg connecting tube 7 is connected with the leg 1 through the opening finger 6, which can prevent the leg connecting tube 7 from being damaged by pressure when the leg 1 is deformed under the pressure of the buckle base; the adjustment structure 5 is mainly used to adjust the degree of tightness of the whole locking device. In the leg locking device for a tripod, the buckle 3 is, through shaft, connected to one end of the buckle base 2; by using of the principle of cam rotation, the cam 31 gradually increases the pulling force on the steel belt 4 during rotation, so that the buckle base 2 is deformed and compressed on the leg 1; when the cam 31 is rotated to the maximum distance, under the reaction force of the steel belt 4, the cam 31 is continuously rotated to make the pinch plate 32 of the buckle 3 pressed onto the buckle base 2, so that the leg is rapidly locked, as the status shown by FIG. 1. When it needs to loosen the locking device, it only needs to move the pinch plate 32 outwards; after the pinch plate 32 makes the cam 31 to rotate over the maximum distance, the force of the cam 31 against the steel belt will be decreased gradually, which makes the buckle base 2 return to the loosen status, as the status indicted by FIG. 3; at this time, there is no pressure from the buckle base 2 against the leg 1; the leg connecting tube 7 can be pulled inside the opening finger 6, so that the leg 1 can be adjusted as to the length and connected.

In this embodiment, the specific structure of the adjustment structure 5 is as following: the adjustment structure 5 comprises a compact 51 and an adjustment screw 52, wherein the compact 51 is placed between the buckle base 2 and the leg 1, and the adjustment screw 52 is turned to penetrate the buckle base 2 and pressed onto the compact 51; through turning the adjustment screw 52 to adjust the force of the compact 51 on the leg 1, the degree of tightness of the whole locking device is adjusted. Of course, the adjustment structure 5 can also adopt other structures, as far as it can realize the function of adjusting the tightness of the whole locking device.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. A leg locking device for a tripod comprising:
a buckle base that telescopes a leg, the buckle base in a form of a circular ring and arranged with an opening;
a buckle including a cam and a pinch plate; and
a steel belt;
wherein the cam is, through a shaft, connected to one end of the buckle base;
wherein one end of the pinch plate is fixed on the cam, and the other end of the pinch plate bends into an arc inward along the buckle base; and
wherein the steel belt rounds the cam and is fixed at the other end of the buckle base reversely with the pinch plate.

2. The leg locking device of claim 1 further comprising an adjustment structure fixed on the buckle base, with one end of the adjustment structure pressed on the leg.

3. The leg locking device of claim 2, wherein the adjustment structure comprises a compact and an adjustment screw;
wherein the compact is placed between the buckle base and the leg; and
wherein the adjustment screw is turned to penetrate the buckle base and is pressed onto the compact.

4. The leg locking device of claim 1, wherein the cam is connected to the buckle base through an inserting shaft.

5. The leg locking device of claim 2, wherein the cam is connected to the buckle base through an inserting shaft.

6. The leg locking device of claim 3, wherein the cam is connected to the buckle base through an inserting shaft.
